(19) United States
(12) Patent Application Publication
(10) Pub. No.: US 2004/0165109 A1
(43) Pub. Date: Aug. 26, 2004

(54) Combination miniature camera and cap for hands free video and method therefor

(76) Inventor: Ben Lee, Woodstock, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/780,793

(22) Filed: Feb. 18, 2004

Related U.S. Application Data
(60) Provisional application No. 60/448,765, filed on Feb. 20, 2003.

(51) Int. Cl. H04N 5/225

(52) U.S. Cl. 348/375

(57) ABSTRACT

A miniature bullet camera connected via cabling means to a camcorder or other suitable recording device, powered by a battery pack, and camouflaged to blend in with a hunter's personal environment, via attachment to a hat or other article of clothing, sporting implement or accessory, utilizing either a clasp, a pin, sewing, gluing, or hook-and-loop fastener material. The present invention may be used by a hunter in pursuing game, where it would be possible to film the game and/or the pursuit thereof from a hidden location without drawing attention to the camera or the hunter himself.

### CROSS-REFERENCES TO RELATED APPLICATIONS

This application claims priority to, and the full benefit of, Provisional Application No. 60/448,765, filed Feb. 20, 2003, entitled “Combination Miniature Camera and Cap for Hands Free Video and Method Therefor”.

### TECHNICAL FIELD

The present invention relates generally to video cameras, and more specifically to a miniature camera for hands free video, wherein the present invention is particularly useful for, although not limited to assisting sportsmen to capture video while leaving their hands free for other tasks.

### BACKGROUND OF THE INVENTION

Many sportsmen are now taking their camcorders into the wilderness in the hopes of filming wildlife as they sit and wait for their desired game. However, current technology requires that the sportsman hold a camcorder device in his hand while filming, thus occupying his hands and hindering expeditious deployment of archery equipment or a desired firearm for harvesting sighted game.

Additionally, many other sports participants are unable to operate video camcorders while actually participating in a sports activity, such as skate-boarding, cycling or roller-blading, wherein any attempts to do so could result in injury to the participant and/or damage to the video equipment. Furthermore, it would be difficult for the sports participant to hold a camcorder and concentrate on filming, while at the same time trying to participate in the sporting activity.

The present invention began out of a need for a device to allow sportsmen to film with a video camera without the necessity of using their hands or focusing their eyes on the subject of the film. By fulfilling such a need, the present invention reduces the risk of injury to a sporting participant or, alternately, allows them to operate other equipment, or both.

Although various camera devices and methods are known, all are disadvantageous when compared to the present invention. Such known devices and methods include helmet-mounted cameras for race car drivers and football players. However, such devices are only suitable for use where it is not necessary to camouflage the appearance of the camera, and offer no ability to provide undetected operation.

Small cameras, typically on the order of two to three inches in size, are also available for the security industry. However, such security cameras are not camouflaged, relying instead on being hidden inside or behind screening partitions.

U.S. Pat. No. 5,583,571 to Friedland teaches a hands-free video recording system that requires an elastic strap with a rigid member for attachment to a desired object, or alternately, that may be attached to a helmet for recording the line-of-sight of the user. However, the device of Friedland is disadvantageous, as it lacks the requisite camouflage to conceal the camera for inconspicuous presence of a hunter, sportsman, or the like, in a wilderness or outdoor setting.

U.S. Pat. No. 6,292,213 to Jones teaches a method for use by athletes or others to record their activities via a camera attached to a base support, such as a headband, goggles or helmet structure in or about the user's person, for transmission of a signal to a central receiver. The method of Jones is disadvantageous in that it lacks camouflage and may be readily observed.

U.S. Pat. No. 5,128,807 to Blackmon teaches a monocular device for magnification of view, wherein the device is mounted on a headgear unit. The device of Blackmon is disadvantageous as it cannot record the images viewed and further lacks camouflage.

While some of the above referenced inventions may well be used for filming activities, they fail to adequately provide camouflage and are further often bulky in nature.

Therefore, it is readily apparent that there is a need for a miniature camera for hands free video. The present invention builds on existing miniature security cameras by camouflaging them for use by hunters and other sportsmen for video surveillance in the field. Such a miniature bullet camera may be connected to a camcorder through the input/output RCA connectors that are standard for this technology. The camcorder and battery pack may be carried by the sportsman into the field in a camouflaged back or belt pack, or similar carrying device.

### BRIEF SUMMARY OF THE INVENTION

Briefly described, the present invention overcomes the above-mentioned disadvantages and meets the recognized need for such a device by providing a miniature camera for hands free video for use by sportsmen to film game, yet which still allows the user's hands to remain free for utilization of archery equipment or firearm of choice for hunting purposes. The present invention further permits participants in other sports to film their activities while remaining free to mentally and physically concentrate on their activity, without the need to attend to their camera device.

According to its major aspects and broadly stated, the present invention is a camera device which is connected via cabling means to a camcorder or other suitable recording device, powered by a battery pack.

More specifically, the present invention in its preferred embodiment is a miniature bullet camera that is camouflaged to blend in with a hunter's personal environment, wherein the device attaches to a hat or other article of clothing, sporting implement or accessory, via a clasp, a pin, hook-and-loop fasteners, stitching or glue adhesives.

The present invention relates to a device that could be utilized by a hunter in pursuing game, wherein the hunter is able to film the game, and the pursuit of same, from a hidden location without drawing attention to the camera or the hunter himself.

A feature and advantage of the present invention is its ability to allow operation without the need to utilize hands.

A further feature and advantage of the present invention is that it is suitable for participant sports, enabling full attention to be focused on the activity without the need of utilizing a traditional viewfinder.

A feature and advantage of the present invention is its miniature size, thus facilitating its camouflage within clothing.

A feature and advantage of the present invention is its ease of manufacture and low production costs.

A further feature and advantage of the present invention is its ease of operation.

A further feature and advantage of the present invention is its ability to be installed and set up by someone other than the ultimate user, thus allowing one person to prepare the device for use by another.

Still another feature and advantage of the present invention is its ability to record a user's activities for future recall.

These and other objects, features and advantages of the present invention will become more apparent to one skilled in the art from the following description and claims when read in light of the accompanying drawings.

### BRIEF DESCRIPTION OF THE DRAWINGS

Having thus described the invention in general terms, the present invention will be better understood by reading the Detailed Description of the Preferred and Selected Alternate Embodiments with reference to the accompanying drawing figures, which are not necessarily drawn to scale, and in which like reference numerals denote similar structures and refer to like elements throughout, and in which:

FIG. 1A is a perspective view of the device according to a preferred embodiment of the present invention.

FIG. 1B is a side view of the device according to a preferred embodiment of the present invention.

FIG. 2 is a perspective view of the device according to a preferred embodiment of the present invention, detailing the camera holder component of FIG. 1A.

FIG. 3 is a perspective view of the camera device of a preferred embodiment of the present invention with connecting cabling.

### DETAILED DESCRIPTION OF THE PREFERRED AND SELECTED ALTERNATIVE EMBODIMENTS

In describing the preferred and selected alternate embodiments of the present invention, as illustrated in the Figures, specific terminology is employed for the sake of clarity. The invention, however, is not intended to be limited to the specific terminology so selected, and it is to be understood that each specific element includes all technical equivalents that operate in a similar manner to accomplish similar functions.

The present invention is suitable for use by hunters and other outdoor sportsmen for video filming their view without the need for hand operation. Additionally, the device may be utilized by participants in any sporting or other physical activity requiring the operation of a device without the use of hands.

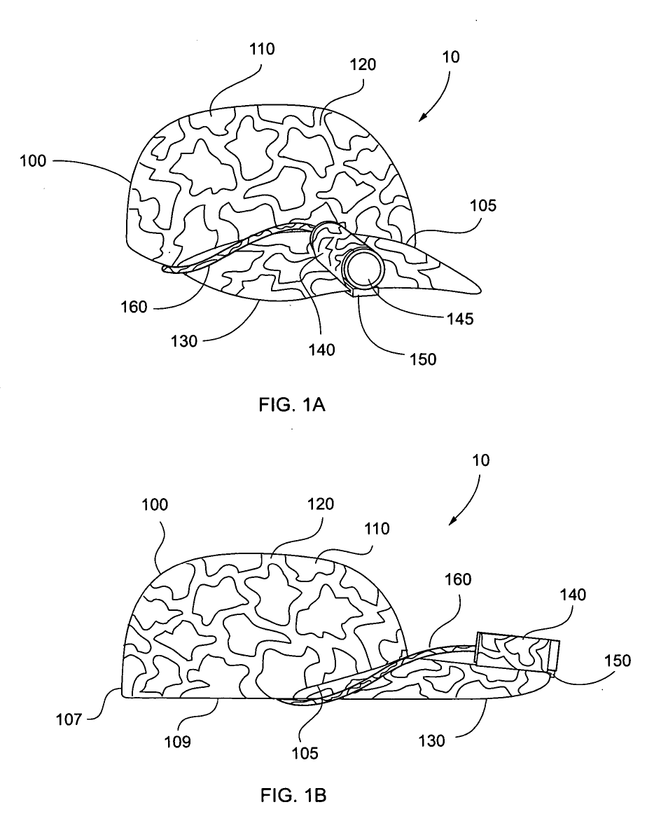

Referring now to FIGS. 1A and 1B, camera apparatus 10 is preferably a cap or hat 100 that may be worn by a sportsman, wherein a sportsman is preferably defined as anyone pursuing an activity generally considered to be sporting in nature, such as, for exemplary purposes only, hunting, bird watching, game photographing, hiking, mountain climbing, skiing, and similar activities. Hat 100 preferably has thereon first camouflage color 110 and second camouflage color 120, preferably in a suitable pattern on hat 100 to assist in blending into the sportsman's chosen environment.

Hat 100 preferably further has bill 130, extending from base 105 thereof, as is known in the art. Preferably located on bill 130 is camera holding body 140, such as for exemplary purposes only, a sleeve or tube, having micro bullet camera 145 contained therein, where micro bullet camera 145 is preferably a video camera. Camera holding body 140 is preferably removably secured to bill 130 via attachment means 150, preferably in the form of a clip, although other suitable fastening mechanisms could be utilized, such as, for exemplary purpose only, clasps, glue, sewing means, or hook-and-loop fasteners. Alternatively, camera holding body 140 may be permanently secured to bill 130 via permanent attachment means, such as, for exemplary purposes only, gluing or stitching.

Preferably extending from micro bullet camera 145 is cabling 160, wherein cabling 160 is preferably routed along bill 130 to rear 107 of hat 100, such that cabling 160 preferably passes rearward and proximate base 109 of hat 100, continuing behind the head of the wearer, and thereafter, passing unobserved behind the wearer to a rearward location, such as, for exemplary purposes only, a back pack or belt pack preferably having a conventional recording device therein. Cabling 160 is further in electrical communication with micro bullet camera 145 and the conventional recording device. Attachment means 150, micro bullet camera 145, and cabling 160 are all preferably colored with a camouflage pattern.

It is contemplated that micro bullet camera 145 could contain one or more integrated microphones for audio signal capture and transformation or, alternatively, one or more external microphones.

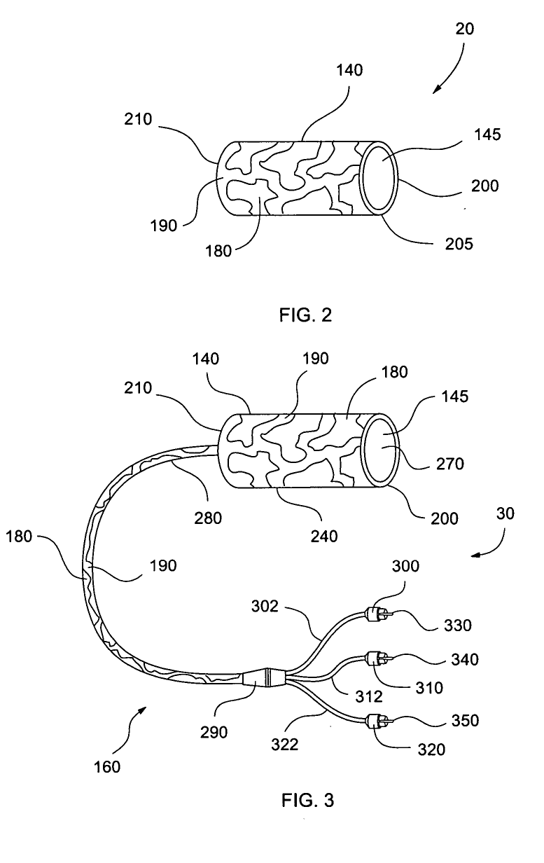

Referring now to FIG. 2, illustrated therein is camera holder 20, preferably comprised of camera holding body 140 in the form of elastic sleeve 205. Camera holding body 140 preferably possesses thereon first camouflage color 180 and second camouflage color 190, preferably forming a suitable pattern to assist camera holding body 140 to blend with the personal environment of the wearer. Camera holding body 140 is preferably located on bill 130 of hat 100 such that first end 200 of camera holding body 140 is directed forward, and second end 210 of camera holding body 140 is directed to rear 107 of hat 100. Micro bullet camera 145 is preferably placed into camera holder 20 to reside in camera holding body 140 by inserting through second end 210, such that the front of micro bullet camera 145 extends through camera holder 20 to first end 200. Thusly, cabling 160 will trail and be in position such that it may be routed to the rear of hat 100. Alternately, it will be recognized by those skilled in the art that cabling 160 could be inserted through first end 200, passing through camera holding body 140 and exiting through second end 210. Micro bullet camera 145 could then be placed into camera holder 20 by inserting into first end 200 until lens 270 of micro bullet camera 145 resides generally flush with first end 200.

FIG. 3 shows in greater detail micro bullet camera assembly 30 having micro bullet camera 145 and camera holding body 140, wherein micro bullet camera 145 has appropriate functional cabling 160 connected thereto, and wherein camera holding body 140 preferably has first end 200, second end 210 and body section 240. Camera holding body 140 preferably has thereon first camouflage color 180 and second camouflage color 190, preferably selected to blend into the environment of use. Preferably located at first end 200 is camera lens 270, through which micro bullet camera 145 views the surroundings. Cabling lead 280 preferably exits proximal second end 210, wherein lead 280 carries a signal obtained by micro bullet camera 145 to a recording device. Cabling lead 280 is preferably colored in camouflage colors 180 and 190, and contains patterns similar to those on camera holding body 140.

Cabling lead 280 is preferably approximately three to six feet in length and terminates in wire exit connector 290, from which preferably extend three wires 302, 312 and 322. Wires 302, 312, 322 each preferably carry different signals, and further preferably terminate in video signal wire housing 300, audio signal wire housing 310, and power supply wire housing 320, respectively. Video signal wire housing 300 has therein video signal wire plug 330 for electrical communication to video input of a recording device. Audio signal wire housing 310 has therein audio signal wire plug 340 for electrical communication to audio input of a recording device. Power supply wire housing 320 has therein power supply wire plug 350 for obtaining power for micro bullet camera 145 from a recording device. Video signal wire plug 330, audio signal wire plug 340 and power supply wire plug 350 are preferably RCA type plug connectors; although other suitable connectors could be utilized, such as, for exemplary purposes only, s-video, other digital or analog feeds, composite video and component video.

It is envisioned that device 10 could alternatively be suited to wireless operation, wherein micro bullet camera 145 could have therein a radio or other rf or emf transmitter for communicating through transmission of frequencies to a receiving device mounted remotely, either on the person of the user or at a separate location. In such a case, micro bullet camera 145 would require a separate source of power, such as a battery, or the like.

In another alternative embodiment, device 10 could be incorporated into a vehicle or into some article that may be carried by an individual, where such an article has an entirely separate function unrelated to filming. It could further, through the use of appropriate camouflage colors, be blended into shrubbery, turf or rocky surroundings.

In yet another alternative embodiment, a still camera could be incorporated into device 10, operated at the command of the wearer through an appropriate control mechanism.

It is further envisioned that an alternative embodiment could include a plurality of cameras, so that the field of vision could be increased.

It is contemplated that night vision camera equipment could be utilized, thus providing a full range of reduced light photography.

It is further contemplated that device 10 could include the ability to zoom nearer and farther from the object of view.

It is also contemplated that device 10 could be positioned to observe rearward, by securing on the rear of hat 100.

In yet another contemplated embodiment, device 10 could include a means of illumination, for use when ambient light conditions require more illumination for adequate quality of recorded view.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely numbering or listing the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A camouflaged image capturing device, comprising:
a camera;
camouflage means carried on said camera for blending in with a user's environment; and
fastening means for attachment of said camera to the user.

2. The camouflaged image capturing device of claim 1, wherein said camera is a miniature video camera.

3. The camouflaged image capturing device of claim 1, further comprising sound capturing means.

4. The camouflaged image capturing device of claim 3, wherein said sound capture means comprises at least one microphone.

5. The camouflaged image capturing device of claim 1, further comprising cabling means having wires for carrying video signals, audio signals and power for said camera.

6. The camouflaged image capturing device of claim 5, wherein said cabling means terminates in at least one RCA plug.

7. The camouflaged image capturing device of claim 1, wherein said fastening means is selected from the group consisting of hook-and-loop fasteners, clasps, clips, glue, and sewing means.

8. The camouflaged image capturing device of claim 1, further comprising means for holding said camera, wherein said holding means is camouflaged.

9. The camouflaged image capturing device of claim 8, wherein said holding means is a sleeve.

10. The camouflaged image capturing device of claim 1, further comprising a video recorder.

11. A method for hands-free camera operation comprising the steps of:
a) providing a camera having means for attachment;
b) providing means for communication with a recording device;
c) establishing communication between said camera and said recording device via said means for communication; and
d) attaching said camera to an article of clothing, accessory or sporting implement via said means for attachment.

12. The method for hands-free camera operation of claim 11, wherein said camera is camouflaged.

13. The method for hands-free camera operation of claim 11, wherein said means for communication is a wireless transmitter/receiver combination.

14. The method for hands-free camera operation of claim 11, wherein said means for communication is a cable.

15. The method for hands-free camera operation of claim 14, wherein said cable comprises wires for carrying video signals, audio signals and power for said camera.

16. The method for hands-free camera operation of claim 15, wherein said cable terminates in at least one RCA plug.

17. The method for hands-free camera operation of claim 11, further comprising the step of providing means for receiving sound.

18. A combination cap and image capturing system, comprising:
a camouflaged image capturing device;
a cap having a bill;
attachment means for holding said camouflaged image capturing device to said bill;
a recording device having receiving means for accepting an electronic signal; and
communication means for transmitting an electronic signal from said camouflaged image capturing device to said recording device.

19. The apparatus of claim 18, further comprising a power source for said camouflaged image capturing device and said recording device.

20. The apparatus of claim 18, wherein said communication means is cabling.

21. The apparatus of claim 18, wherein said communication means is a radio frequency transmitter and receiver.

22. The apparatus of claim 20, wherein said cabling comprises wires for carrying video signals, audio signals and power for said camouflaged imaging device.

23. The apparatus of claim 22, wherein said wires terminate in at least one RCA plug.

24. The apparatus of claim 18, further comprising means for capturing sound.

25. The apparatus of claim 18, wherein said camouflaged image capturing device is a camouflaged bullet video camera.
